(19) United States
(12) Patent Application Publication
(10) Pub. No.: US 2005/0102249 A1
(43) Pub. Date: May 12, 2005

(54) Methods and apparatus for customization of rule-based applications

(76) Inventor: Joseph P. Bigus, Rochester, MN (US)

Correspondence Address: Moser, Patterson & Sheridan, Suite 100, 595 Shrewsbury Avenue, Shrewsbury, NJ, 07702, US

(21) Appl. No.: 10/712,828

(22) Filed: Nov. 12, 2003

(51) Int. Cl. G06F 17/00

(52) U.S. Cl. 706/47

(57) ABSTRACT

An improved method for customization of rule-based applications, such as business process rules and policy. A template keyword modifier is used in the source language and an object-oriented framework is used for managing the creation and maintenance of rulesets and individual rules generated through customization of templates. A method provides generation of rulesets and rules and constrained editing of rule logic through use of template variables, template rules and template rulesets. Embodiments allow separation of complex business logic from less complex domain knowledge that can be maintained by a non-programmer domain expert, such as a business manager.

### BACKGROUND OF THE INVENTION

1. Field of the Invention

The present invention generally relates to the data processing field. More specifically, the present invention relates to the field of machine inferencing and reasoning, commonly referred to as business rules and policy-based management.

2. Description of the Related Art

Since the advent of the first electronic computers in the 1940s, computers have expanded from performing complex numeric calculations, to processing increasingly complex symbolic programming languages (FORTRAN, COBOL, Pascal, C, C++, Java, and the like), to data representing text, documents, images and speech. During this same period, programming approaches have evolved from assembly language (binary machine code) to structured programming techniques, and finally to current object-oriented approaches as represented by the Smalltalk, C++ and Java programming languages. These programming languages require programmers to specify the sequences of operations necessary to perform the data processing functions of the application, and are referred to as procedural languages.

In the late 1950s, efforts began to explore the application of computers to machine reasoning in an effort to duplicate the reasoning ability of humans. This so-called artificial intelligence (AI) programming field produced several new languages, notably Lisp and Prolog, as well as an entirely different approach to programming referred to as declarative. In declarative programming, the data processing functions are specified by sets of if-then rules (the knowledge), sets of data to be processed, and a control program called an inference engine. Traditionally, the format and representation of the rules were tightly joined and tailored to the underlying inference engine. For example, Prolog is based on predicate logic and uses a unique syntax and a corresponding back chaining or goal-oriented inference strategy using back tracking. A popular forward chaining or data-driven inference approach uses a sorting network (Rete' network) popularized in the OPS/CLIPS rule languages. IBM developed a forward chaining product based on the PL/I programming language called KnowledgeTool in the late 1980s.

A more recent use of rules engines is in the processing of so-called business rules. Companies such as ILog and Fair Isaacs (Blaze) offer software products with tightly coupled rules languages (syntax) and inference engines. These inference engines allow business applications to externalize business logic by representing the logic as rules. Another major usage of rule processing is in the area of policy-based management such as WS-Policy in the Web Services application area.

A major issue in the use of rule-based systems is the definition and maintenance of business policy specifications (i.e., rules) by domain experts who may be non-information technology (non-IT) specialists. It would be desirable to provide an easy way to customize rule-based applications.

### SUMMARY OF THE INVENTION

In one embodiment according to the present invention, a method and apparatus for customizing a rule-based application is provided. One embodiment comprises designating a customizable element of a set as a customizable template, and compiling the customizable element into at least one object to form a ruleset.

One advantage of embodiments according to the present invention includes providing a rule language with means of designating (signifying) that elements of a ruleset are customizable templates. The generation of rulesets and rules from templates is facilitated. Previously generated rules can be edited/customized at a later time with ease.

In another embodiment, a rule language has the capability to designate an entire ruleset as a template. The framework mechanism allows generation of a customized ruleset from that template.

In another embodiment, a rule language has the capability to designate a rule as a template with portions of the rule logic fixed and portions customizable.

### BRIEF DESCRIPTION OF THE DRAWINGS

The teachings of the present invention can be readily understood by considering the following detailed description in conjunction with the accompanying drawings, in which:

FIG. 1 is a block diagram of an exemplary framework mechanism;

FIG. 2 is a flow diagram showing basic operations when using the framework mechanism without template processing;

FIG. 3 is a flow diagram showing steps used in an exemplary embodiment to perform template processing and customization of a ruleset;

FIG. 4 is a flow diagram showing steps used in an exemplary embodiment to perform a function (parsing of ruleset objects) of the framework mechanism;

FIG. 5 is a flow diagram showing steps used in an exemplary embodiment to perform a function (initialization of ruleset objects) of the framework mechanism;

FIG. 6 is a flow diagram showing steps used in an exemplary embodiment to perform a function (authoring of rulesets with template variables and rules) of the framework mechanism;

FIG. 7 is a flow diagram showing steps used in an exemplary embodiment to perform a function (generation of new rules from rule templates) of the framework mechanism;

FIG. 8 is a flow diagram showing steps used in an exemplary embodiment to perform a function (re-editing of rules that were initially generated from rule templates) of the framework mechanism;

FIG. 9 is a flow diagram showing steps used in an exemplary embodiment to perform a function (generation of a new ruleset from a ruleset template) of the framework mechanism;

FIG. 10 is a screen capture of a web-based interface to load a template ruleset and either generate new rules from templates or edit existing rules already generated from templates, according to one exemplary embodiment;

FIG. 11 is a screen capture of a web-based interface to allow a non-IT specialist to create a new rule from a rule template, according to one exemplary embodiment;

FIG. 12 is a screen capture of a web-based interface showing the rule generated by the data entered in FIG. 11, according to one exemplary embodiment;

FIG. 13 is a screen capture of a web-based interface to generate a new ruleset from a template ruleset, according to one exemplary embodiment; and

FIG. 14 illustrates subsystems found in one exemplary computer system that can be used in conjunction with embodiments according to the present invention.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments according to the present invention provide methods and apparatus for the specification of complex rule-based applications developed primarily by computer programmers, while at the same time supporting customization by non-programmer end-users or domain experts. Secondly, a software architecture is provided that allows customization to be enabled in the deployment environment as well as in the development environment. The foregoing allows increased flexibility for rule-based applications because business managers can easily update business logic without a dependency on IT programming staff.

Embodiments according to the present invention include methods and apparatus that allow a business logic or policy author to write an application comprised of rules, and designate certain parts of that application as available for later customization by end-users or application domain experts. Complex internal rule logic can be hidden and protected from changes by these domain experts, thereby protecting the integrity of the application logic. Additionally, methods and apparatus are contemplated for providing simplified domain-specific user interfaces (UIs) for these users.

In one embodiment, embodiments according to the present invention define a method where a rule language can support ruleset and rule-level templates, and where new rulesets and rules can be generated from previously specified templates.

As mentioned herein, one problem with previous attempts is that it is difficult or impossible to carry along the rule template information once the rules are deployed. It is often the case that the use of rule templates is available only in the pre-deployment development environment. Embodiments according to the present invention allow information about variables and rule templates to be carried along with the run-time instantiation of the ruleset objects. This means that deployed rulesets can be customized and rules generated from templates in the development environment can be edited in the run-time environment.

The rule language structure is an aspect of this invention. In one embodiment, this rule language is the Agent Building and Learning Environment (ABLE) rule language. However, anyone skilled in the art would recognize that this customization method could be applied to other rule languages and dynamic programming languages. One aspect of the present invention is to designate (signify) that variables and rules are templates.

ABLE provides a rule language, development and run-time environment for business rules and policy applications.

The ABLE Rule Language (ARL) template design allows ruleset authors to specify rule-level and ruleset-level templates. From a ruleset author's perspective, the template support is straightforward; simply add the template modifier to rulesets, variables or rules to designate them as templates. This means any ruleset, any built-in or imported data types can be used as template variables, and any ARL rule type can be templatized.

Rules that are generated from templates can be saved to external files as ARL text files or as ARML XML documents and then re-loaded and edited using the original template replacement values. The metadata associated with rule template usage is saved in the ruleset in a special ruleblock called initRuleTemplates( ). This ruleblock can be automatically processed to restore the template context for re-editing of generated rules.

At the rule template level, a ruleset author can write templates that allow:

1. Customization of rule label. Each rule has a unique label in one embodiment.

2. Customization of rule priority (optional).

3. Customization of rule preconditions such as temporal enablement specifications (optional).

4. Customization of variables based on constraints. The template author can set constraints via the choice of template variable data types and values (Categorical, Discrete, Continuous, etc.).

5. Customization of rule logic through use of Expression variables. For example:
if (cond) then {action};
where cond is an Expression variable or action is an Expression variable.

A ruleset author can create rulesets and templates using the ARL Swing RuleSet editor or the WebSphere Studio Application Developer ARL Editor plugin. There are no external artifacts or special-purpose Graphical User Interfaces required to use the templates in the present invention. The ARL compiler parses and generates an AbleRuleSet bean with the template information contained in it. Afterward, an AbleRuleSet bean with templatized components can be customized with PC client or web-based user interfaces via the AbleRuleSet bean template application programming interfaces (APIs).

The variables section is used to declare variables, their attributes including data types and initial values. Embodiments according to the present invention introduce the notion of a template modifier, which marks the variable as a customization variable and not a standard run-time variable used for data processing.

Likewise, the rules in the ruleset can be marked as templates, which mark the rule as a customization rule, and not a standard run-time rule used for data processing.

Template variables and template rules are parsed and compiled into objects in a manner similar to standard variables and rules. However, the template attribute causes special processing, whereby those template objects are ignored as part of the run-time processing of the ruleset. Nevertheless, they are carried along with the source ruleset (whether text of XML) and the run-time AbleRuleSet bean object and are available via the template APIs to be used for customization of the ruleset in either a development (rule authoring) environment or as part of the run-time (deployment) environment.

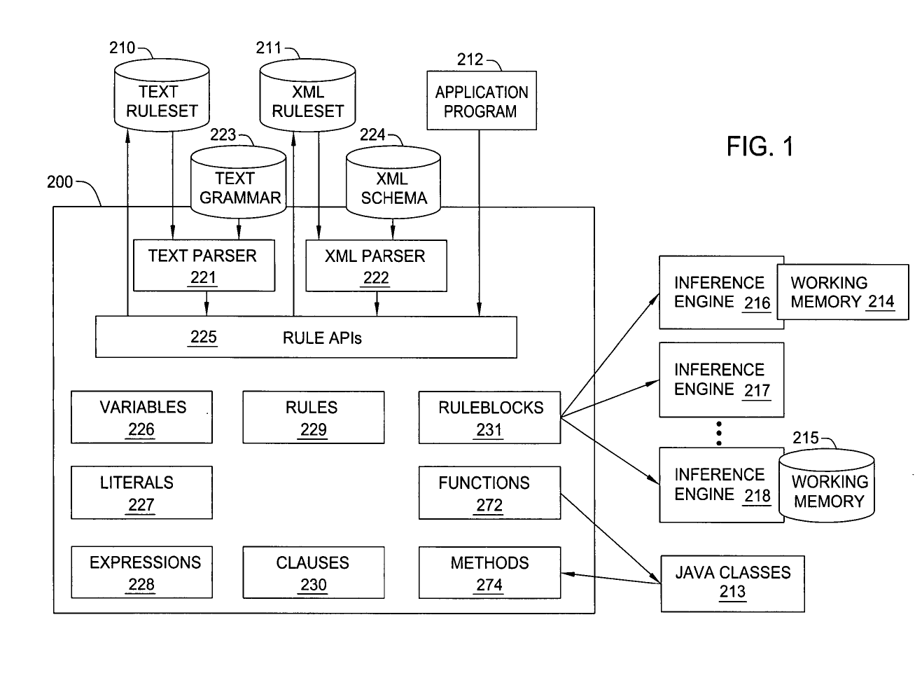

Referring to FIG. 1, a ruleset bean 200 provides a plurality of rule application programming interfaces (APIs) 225 for exercising functions provided by a framework of objects. The APIs 225 include, for example, a rule language text parser 221, which in turn uses a rule language text grammar 223, and a rule language XML parser 222 that makes use of a rule language eXtensible Markup Language (XML) Schema 224. The Antlr compiler generator can be used for the text parsing and the Xerces XML parser can be used for the XML parsing. Alternative compilers exist for both functions. The text parser 221 and the XML parser 222 make use of the APIs 225 to create the instances of the objects that make up the internal data representation of the rulesets. Object types include, for example, variables 226, literals (also known as data constants) 227, mathematical and logical expressions 228, rule objects 229, rule clauses 230, ruleblocks 231, user-defined functions 272 known as sensors and effectors, and method calls 274 on imported classes such as Java Classes 213 or the like.

In one embodiment, a text ruleset 210 comprises a set of rule language specifications, which can be parsed by the text parser 221 and compiled into a collection of objects, for example, variables 226, literals 227 and expressions 228. Using the rule APIs 225, these objects can be converted back into a text ruleset. An XML ruleset 211 comprises a set of rule language specifications, which can be parsed by the XML parser 222 and compiled into a collection of objects. Using the rule APIs 225, these objects can be converted back into an equivalent XML ruleset. An application program 212 can construct a ruleset and a collection of objects using the APIs 225 provided with the framework. A valid ruleset, whether parsed using the text parser 221, the XML parser 222 or the rule APIs 225 results in the creation of an identical collection of objects. These methods provide equivalent capabilities of defining and constructing framework objects 226-233.

Referring yet again to FIG. 1, Java classes 213 can be imported and used by rules in the ruleset. The Java classes 213 can include standard Java language classes such as java.lang.Math, java.util.Vector, etc., and application classes needed by the application.

The inference engines 216, 217, 218 comprise the inference modules provided by the framework and can include additional inference modules provided to extend the framework. These inference engines can optionally use working memory objects 214, 215 to hold instances of objects during inferencing. This flexibility can add enhanced or alternative inference modules (engines) to the framework. The design of the framework explicitly provides for this capability by separating the data (the framework objects of FIG. 1) from the inference or control modules 216, 217, 218.

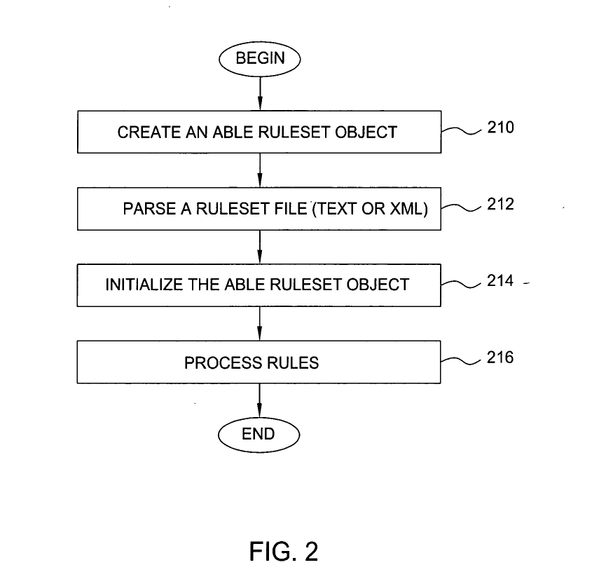

Referring now to FIG. 2, in one embodiment there are four major steps in the usage of the framework to process a ruleset. At step 210, a ruleset bean container object (e.g., an ABLE ruleset object) is instantiated (created). Creating the object is done using a constructor call in Java in one embodiment.

At step 212, the ruleset file is parsed to create the objects shown in FIG. 1. In ABLE, the ruleset can be a text file or an XML document. This step 212 comprises processing the text ruleset 210 or the XML ruleset 211 and converting it into the objects shown in FIG. 1.

At step 214, the ruleset object is initialized by calling an init method (routine) to ready for processing. At step 216, rules of a ruleset are processed. The results are returned after the input data has been processed.

Step 216 can be iterated. In other words, a rule processing step can be called repeatedly. For example, a transaction can be simulated repeatedly with a different set of input data used for each simulation.

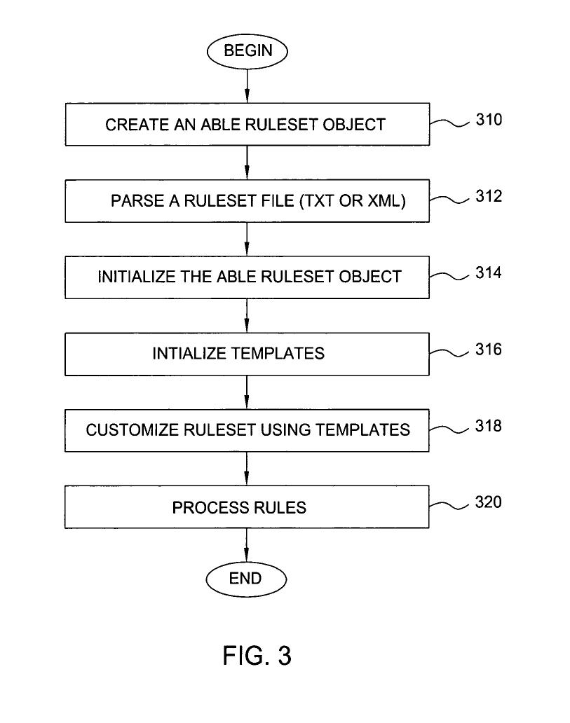

Referring to FIG. 3, a method similar to that of FIG. 2 is depicted. The exemplary method is a method for using a system according to embodiments of the present invention wherein template functionality is now utilized.

At step 310, a ruleset bean container object (e.g., an ABLE ruleset object) is instantiated. Creating the object is done using a constructor call in Java in one embodiment.

At step 312, a ruleset file is parsed to create the objects shown in FIG. 1. In ABLE, the ruleset can be a text file or an XML document as mentioned herein. This step 312 comprises processing the text ruleset 210 or the XML ruleset 211 and converting it into the objects shown in FIG. 1. At step 314, the ruleset object is initialized by calling an init method to ready for processing.

In this embodiment, the ruleset file comprises elements that are marked as templates. In other words, the ruleset file comprises template variables, template rules, etc. At step 316, the templates are initialized via an API call. The system finds any templates and if there is a metadata ruleblock the system will process that ruleblock and make that information available (to facilitate re-editing of generated rules, discussed herein).

At step 318, the ruleset is customized using templates. APIs are used to generate new rules or edit existing rules that had been previously generated from templates. A user interface, discussed herein, is utilized to facilitate this process.

At step 320, the customized rules are processed. The results are returned after the input data has been processed. Step 320 can be iterated. In other words, a rule processing step can be called repeatedly. For example, a transaction can be simulated repeatedly with a different set of input data used for each simulation.

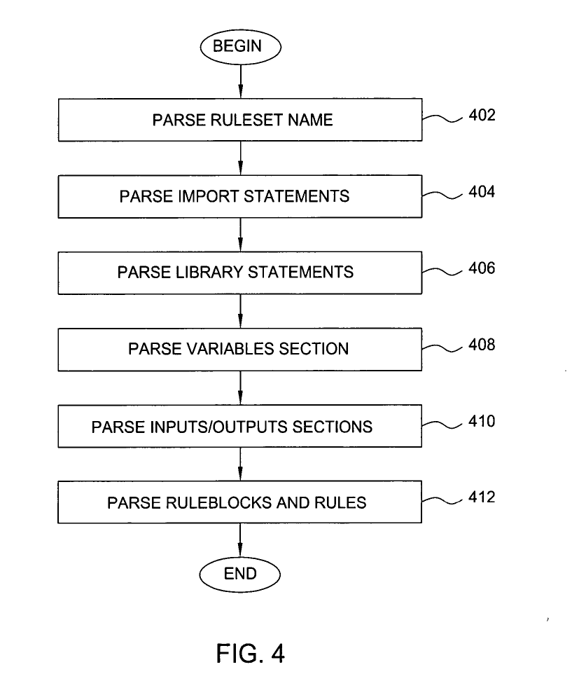

Referring now to FIG. 4, details of how a ruleset is parsed according to one embodiment of the present invention are shown. This process is invoked at step 212 of FIG. 2 or step 312 of FIG. 3.

At step 402, the ruleset name is parsed. The ruleset name is an identifier that names the ruleset. If a template modifier appears before the ruleset keyword, then the ruleset bean is marked (flagged) as a template signifying that it can be used to generate an entire new ruleset.

At step 404, the system parses import statements. These import statements correspond to Java classes. The import statements allow user-defined data types for declaring and manipulating variables of those types. Each declared type is equated to a public Java class.

At step 406, the system parses library statements and constructs user-defined function objects 272. Library statements allow the user to import public methods in specified classes (or libraries) as user-defined functions without needing to declare each method explicitly. Library functions then become available to be called from rules.

At step 408, the variables section is parsed and a collection of variable objects 226 and literal objects 227 are instantiated. Variables 226 that have the template modifier in front of them are marked as template variables, meaning they can be used as customization points in other ruleset elements.

At step 410, the list of input and output variables are parsed. One or more ruleblocks are parsed, creating ruleblock objects 231 and rule objects to be instantiated.

At step 412 one or more ruleblocks are parsed, creating ruleblock objects 231 and rule objects to be instantiated. A ruleset can comprise one or more ruleblocks, and rules in one ruleblock can invoke rules in other ruleblocks. Each ruleblock is processed by a corresponding inference engine specified by a “using” clause, referred to herein. The source text or XML ruleset has been converted into internal objects. If a template modifier appears before the rule header, the rule is marked as a rule template, meaning it can be used to generate new rules. At the end of processing of FIG. 4, the source text or XML ruleset has been converted into internal objects.

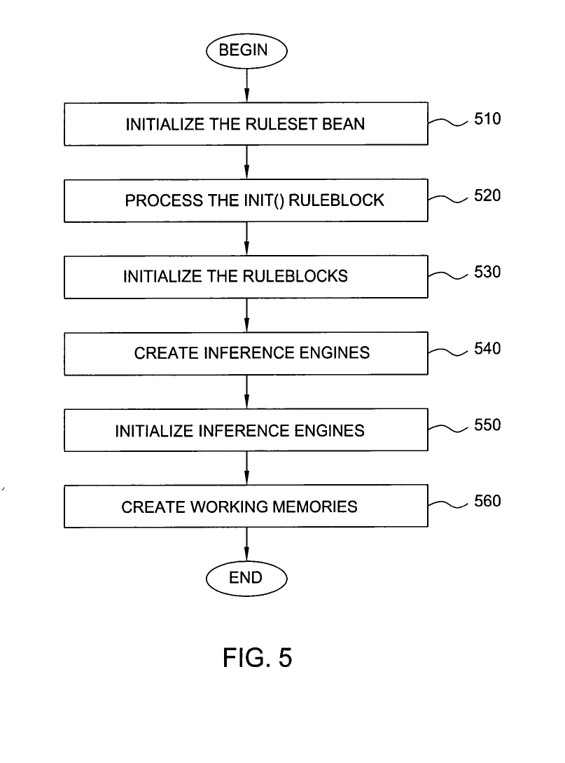

Referring now to FIG. 5, an exemplary initialization sequence of a bean is illustrated wherein the system is preparing to process rules (the objects of FIG. 1 have already been generated, as discussed herein). This process is performed at step 214 of FIG. 2 or step 314 of FIG. 3.

At step 510, the ruleset bean object is initialized. At step 520, an init ruleblock is processed if one has been defined. At step 530, the system traversed the entire ruleset and initializes ruleblocks in sequence.

At step 540, an instance of the inference engine specified in the “using” clause is created and at step 550 this inference engine object is initialized. Operations can comprise transformations of rule objects into local data structures and instance variables used by the engine to process the rule objects. Depending on the type of inference engine associated with the ruleblock, a working memory object can be instantiated at step 560.

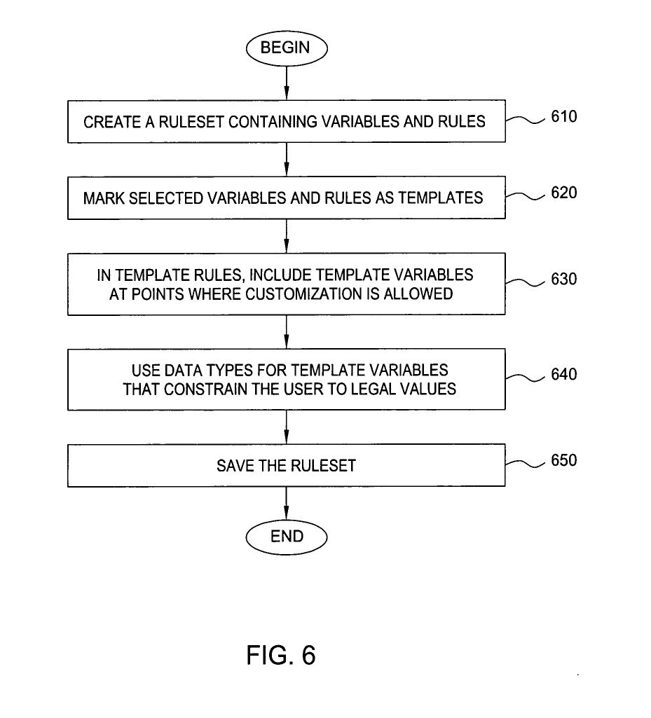

FIG. 6 illustrates basic steps of authoring a ruleset with template elements, according to one exemplary embodiment. At step 610, a ruleset is created containing variables and rules. At step 620, selected variables and rules are marked (annotated) as templates using a template modifier.

At step 630, template variables are included in template rules at points where customization is allowed (i.e., where it is desired that a user have the capability to modify the structure of a rule). At step 640, data types are used for template variables that constrain the user to legal values. As a user modifies a rule and signifies what portions of the rule logic are customizable (by virtue of using template variable names there) the user can also (by virtue of the type of template variable the user is using) constrain the values and the ultimate structure of the rules that are generated by that template. For example, if the user wants to limit valid values to be the 50 U.S. states, the user uses a template variable called, e.g., “State Value.” The variable is actually a categorical variable with legal values being the names (or representative, codes, abbreviates, etc.) of the 50 states. At customization time of the given ruleset, the end-user can thus only choose one of those 50 values. Although the example given here is a discrete list of valid values, ranges on numerical values, etc. can be used. At step 650, the ruleset is saved (at author time) to an external file. The ruleset can be customized later, as discussed herein.

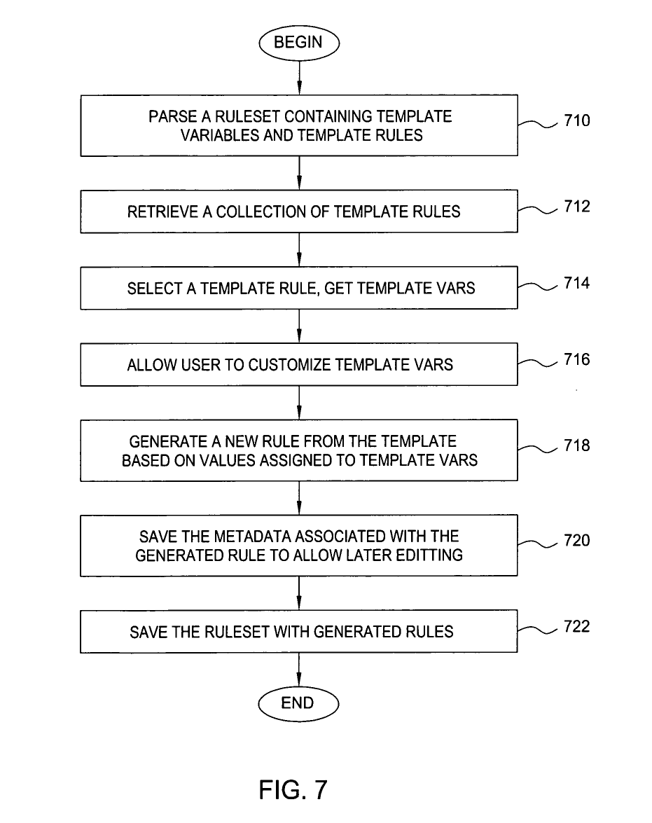

FIG. 7 shows exemplary steps used in generating a new rule from a rule template (i.e., a customization process at the rule level). A user (IT developer, etc.) has already generated a ruleset that comprises template elements. The ruleset object has been created in step 210 of FIG. 2 or step 310 of FIG. 3.

At step 710, the system parses the ruleset containing template variables and template rules (which were identified in the process of FIG. 6). At step 712, a collection of template rules is retrieved from the ruleset object or bean 220. An API is called for this purpose.

At step 714, a template rule is selected via a user interface or the like. Upon selection, an API is called to retrieve the contained template (customizable) variables.

At step 716, an end-user is allowed to customize template variables. A user interface or the like is presented to the end-user so the end-user can provide replacement values for those template variables. Depending upon the type of variable, the end-user can be constrained to using certain variable values, as mentioned herein, to ensure that the resulting rule will be valid.

At step 718, a new rule is generated from the template based on the values assigned to the template variables. At step 720, metadata associated with the generated rule is saved to the initRuleTemplates( ) ruleblock to allow for subsequent re-editing. At step 722, the ruleset is saved with the generated rules. It is noteworthy that steps 714, 716, 718 and 720 can be iterated for multiple template rules. An end-user can select different types of templates (or the same type of template but provide different values) and generate multiple rules.

In one embodiment, it is noteworthy that when an entire (new) ruleset is generated from a ruleset template, the rule templates are carried over unchanged. For example, if a ruleset exists that is used to compute discounts, it may be desirable to allow a customer to generate a new ruleset. They customer and system may, for example, customize the company name and other general attributes, but carry over several discount rule templates (for use once the generated ruleset is deployed).

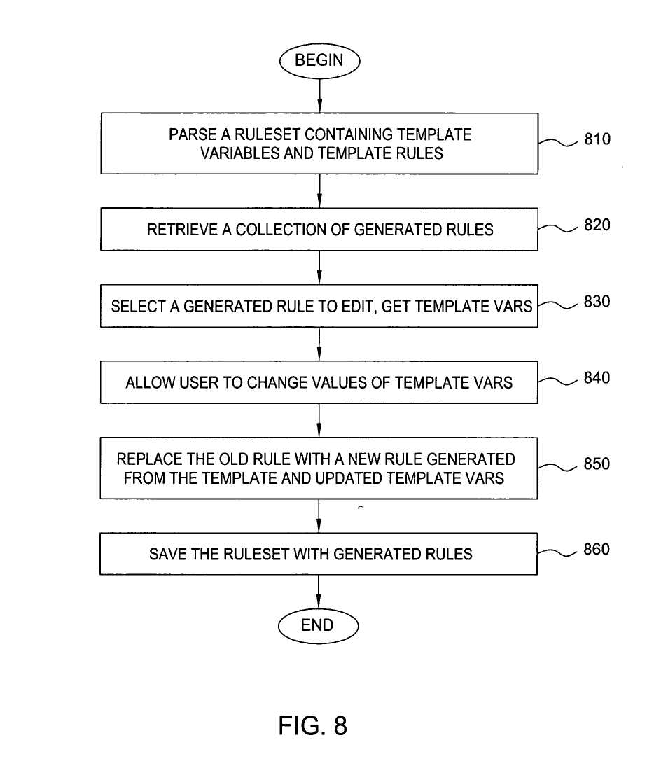

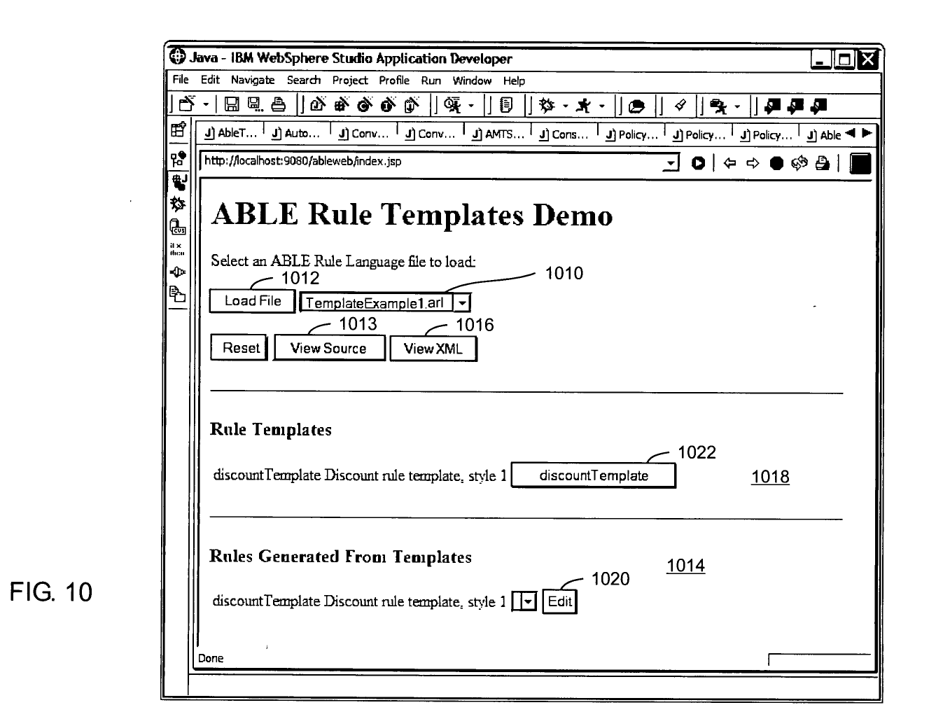

FIG. 8 illustrates exemplary steps involved in re-editing a rule that was previously generated from a rule template. At step 810, a ruleset is parsed that contains template variables and template rules, as described with respect to FIG. 7. (A list of templates that an end-user can select is shown in FIG. 10 in the field 1010.) At step 820, a collection of generated rules is retrieved from the ruleset object or bean 200 via an API. (A list of generated rule(s) to edit is shown in the area 1014 of FIG. 10 and can be selected via a pull-down menu.)

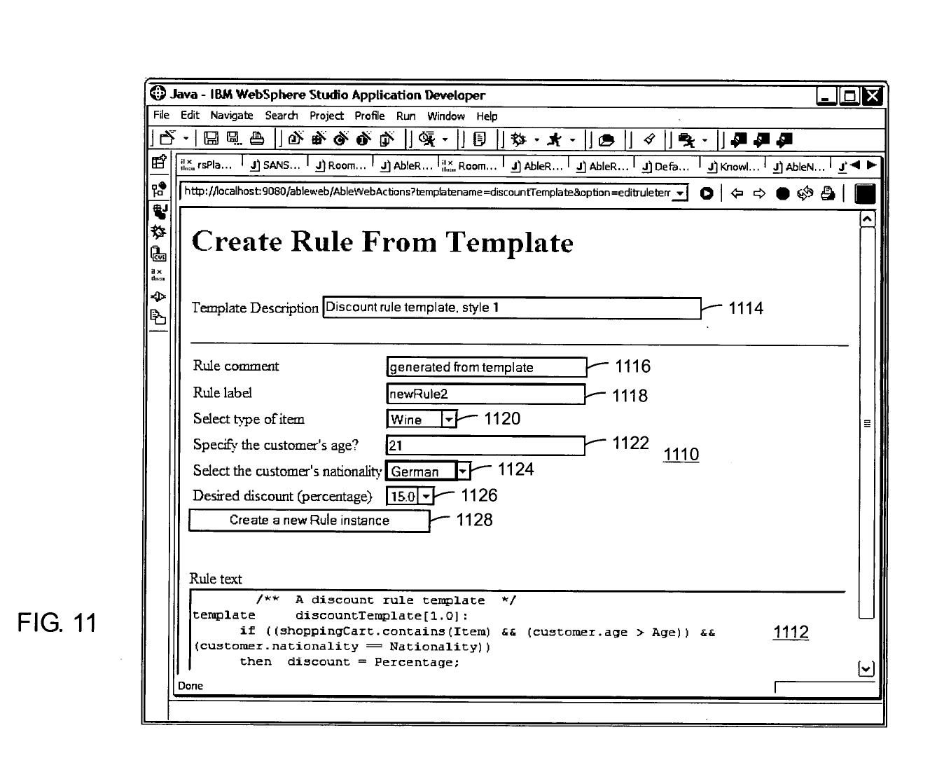

At step 830, a generated rule to edit is selected (from area 1014 of FIG. 10) and the system obtains template variables. At step 840, a user is allowed to change the values of template variables (see FIG. 11). At step 850, an old rule is replaced with a new rule generated from the template and updated template variables. At step 860, the ruleset is saved with generated rules. It is noteworthy that steps 830, 840 and 850 can be iterated to edit multiple generated rules.

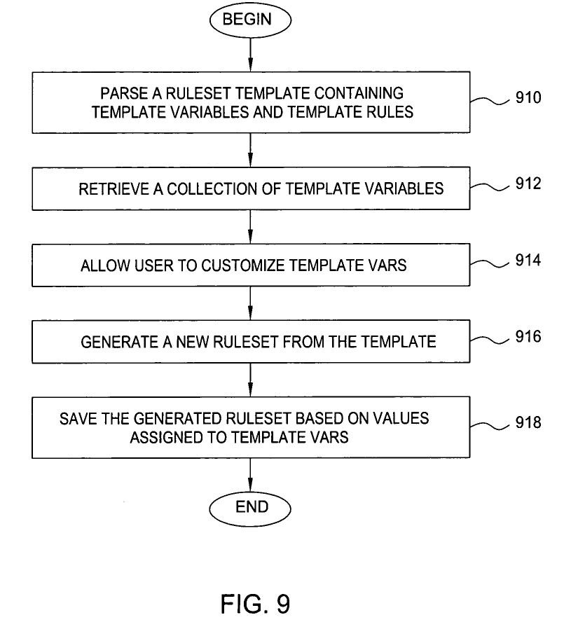

FIG. 9 depicts exemplary steps involved in generating an entire new ruleset from an existing ruleset template. A ruleset represents a template for an application. An end-user can customize that ruleset and generate an entirely new ruleset (or application).

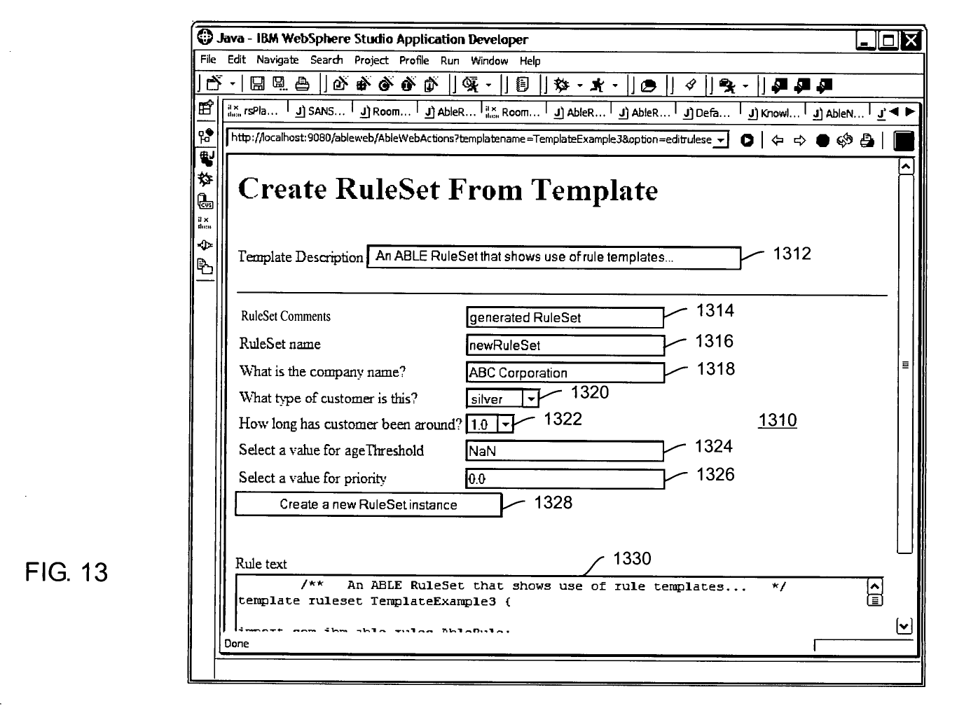

At step 910, a ruleset template is parsed that contains template variables and template rules. At step 912, a collection of template variables is retrieved from the ruleset object or bean 200 via an API. At step 914, a user is allowed to customize template variables with concrete values (see FIG. 13). At step 916, a new ruleset is generated from the template (see FIG. 13). At step 918, the generated ruleset is saved to an external file based on values assigned to the template variables.

FIG. 10 is a screen capture of an exemplary web-based interface used to load a template ruleset and either generate new rules from templates or re-edit existing rules already generated from templates. The end-user selects which ruleset template to load, in field 1010. The user can view the source code by selecting the video button 1013 or the XML code by selecting the video button 1016. The user can load the ruleset template by selecting the video button 1012 (this causes the parsing to be performed, mentioned herein). A list of rule template(s) that can be used to create new rules is shown is the area 1018. Selecting the video button 1022 allows an end-user to generate a new rule from a template (FIG. 11). A list of generated rule(s) to edit can be shown in the area 1014 and can be selected via a pull-down menu, as mentioned herein. The end-user can (re-)edit a generated rule by selecting the video button 1020.

FIG. 11 is a screen capture of an exemplary web-based interface for allowing a user such as a non-IT specialist or non-programmer to author (create) a new rule from a rule template. In area 1110, a user can enter text and/or values into various fields and effectively assign values to template variables. The user is constrained by the types of variables used and valid values for those variables, as mentioned herein.

A description of the rule is entered in field 1114. A comment can optionally be entered in field 1116. The end-user enters, in field 1118, a label to identify the rule being created. In this example, the type of item is constrained and can be selected from pull-down menu 1120. The end-user has selected “Wine” in this particular case.

In field 1122, the end-user enters the customer's age (e.g., 21). In field 1124, the end-user selects the customer's nationality (e.g., German) from a constrained set of allowed nationalities. In field 1126, the end-user selects a discount percentage from a constrained set of allowed discrete values. Thus, the end-user has been allowed to customize template variables, as referred to in step 716 of FIG. 7 and step 914 of FIG. 9. Selecting video button 1128 corresponds to step 718 of FIG. 7 involving generating a new rule from the template based on values assigned to template variables. In area 1112, rule text is produced. This source code includes rule syntax.

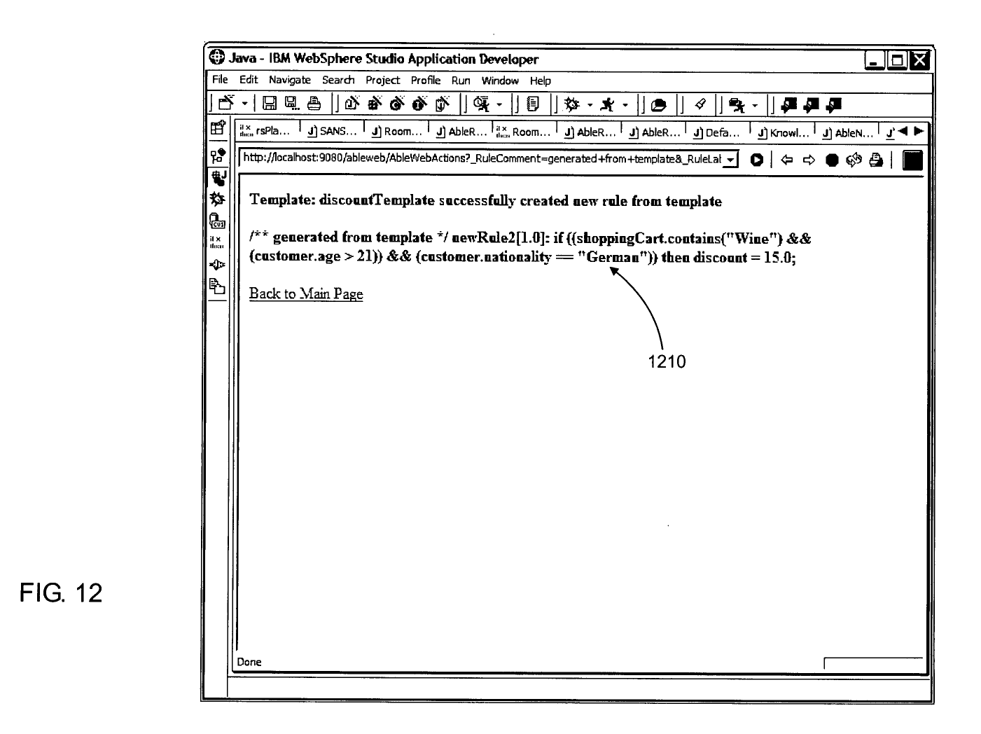

FIG. 12 is a screen capture of an exemplary web-based interface showing the rule 1210 generated by the data entered in FIG. 11. Values entered in area 1110 are substituted for variables in area 1112 to produce rule 1210. This generated rule will show up in area 1014 of FIG. 10 and can be re-edited.

FIG. 13 is a screen capture of an exemplary web-based interface to generate a new ruleset from an existing ruleset template. Information pertaining to the customer and the like can be entered in various fields as shown. In area 1310, the end-user can customize the template variables as described with respect to step 914 of FIG. 9.

A template description is entered in field 1312 by the end-user. A template ruleset comment can be entered in field 1314 by the end-user. A ruleset name is entered in field 1316 by the end-user. A company name (e.g., ABC Corporation) is entered in field 1318 by the end-user. A customer type is entered in field 1320 by the end-user by selecting from a pull-down menu. A number representing how long the customer has been around is entered in field 1322 by the end-user by selecting from a pull-down menu. An age threshold value is entered in field 1324 by the end-user. A priority value is entered in field 1326 by the end-user (e.g., 0.0). The end-user can select video button 1328 to create a new ruleset instance as described with respect to step 916 of FIG. 9.

It is noteworthy that the exemplary screen captures (screen shots) shown herein are for illustrative purposes only. Any suitable UI can be used.

In summary, in one embodiment a program product comprises a rule language with means of signifying that elements of a ruleset (variable, rule, or entire ruleset) are templates (meaning they can be customized). The program product further comprises an object-oriented framework mechanism or run-time that allows the generation of rulesets and rules from templates and allows editing of previously generated rules. The framework mechanism executes on the central processing unit and signal bearing media bearing the framework mechanism.

In another embodiment, a rule language is contemplated that has the capability to designate an entire ruleset as a template. The framework mechanism allows generation of a customized ruleset from that template.

In another embodiment, a rule language is envisioned that has the capability to designate a rule as a template with portions of the rule logic fixed and portions customizable.

In one embodiment, the following steps are used by a ruleset author to create and use templates. An ARL ruleset source file is created. Variables, ruleblocks, rules, etc., are defined. Template variables, rules or rulesets are defined. The ruleset is compiled into a run-time AbleRuleSet bean. Editing is then allowed so that domain experts can author new rules.

The ABLE Rule Language template design allows ruleset authors to specify rule-level and ruleset-level templates. The ARL template design introduces two new classes to ABLE, the AbleRuleSetTemplate and the AbleRuleTemplate. The primary template APIs are provided by the AbleRuleSet bean. User interfaces can extract and set information on the template objects and then use the AbleRuleSet APIs to instantiate the new rulesets or rule objects.

In one embodiment, an entire ABLE ruleset can be used as a template to generate new rulesets. To enable this, the template modifier is placed before the ruleset and one or more variables referenced in the ruleset are to use the template modifier.

Moreover, a single ABLE rule can be used as a template to generate new rules. To enable this, the template modifier is placed before the rule label and one or more variables referenced in the rule are to use the template modifier.

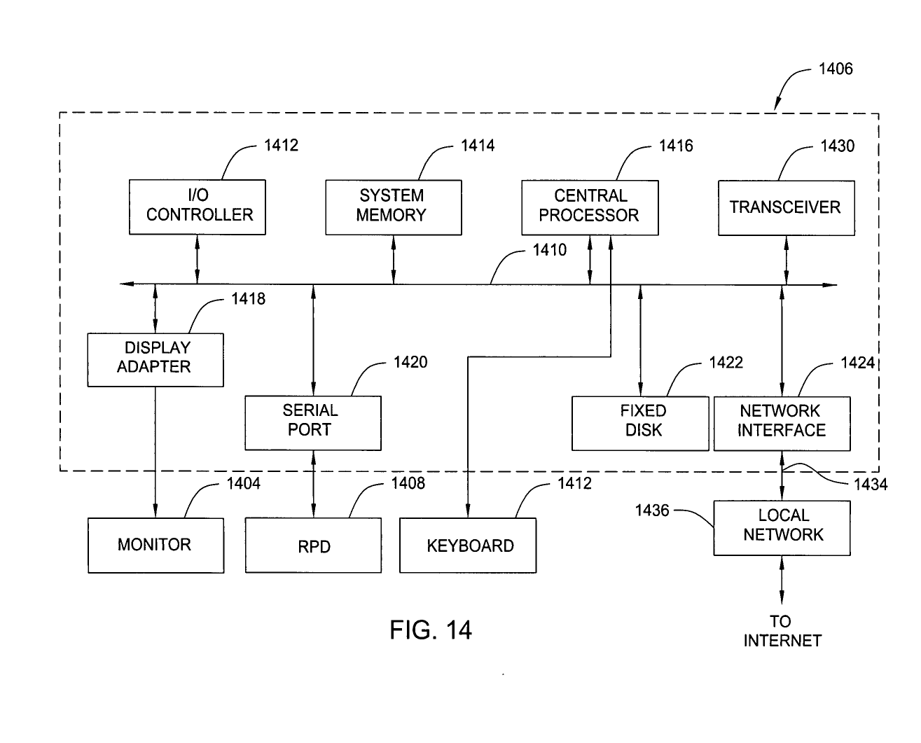

FIG. 14 illustrates subsystems found in one exemplary computer system, such as computer system 1406, which can be used in accordance with embodiments of the present invention. Computers can be configured with many different hardware components and can be made in many dimensions and styles (e.g., laptop, palmtop, server, workstation and mainframe). Thus, any hardware platform suitable for performing the processing described herein is suitable for use with the present invention.

Subsystems within computer system 1406 are directly interfaced to an internal bus 1410. The subsystems include an input/output (I/O) controller 1412, a system random access memory (RAM) 1414, a central processing unit (CPU) 1416, a display adapter 1418, a serial port 1420, a fixed disk 1422 and a network interface adapter 1424. The use of bus 1410 allows each of the subsystems to transfer data among the subsystems and, most importantly, with CPU 1416. External devices can communicate with CPU 1416 or other subsystems via bus 1410 by interfacing with a subsystem on bus 1410.

FIG. 14 is merely illustrative of one suitable configuration for providing a system in accordance with the present invention. Subsystems, components or devices other than those shown in FIG. 14 can be added without deviating from the scope of the invention. A suitable computer system can also be achieved without using all of the subsystems shown in FIG. 14. Other subsystems such as a CD-ROM drive, graphics accelerator, etc., can be included in the configuration without affecting the performance of computer system 1406.

One embodiment according to the present invention is related to the use of an apparatus, such as computer system 1406, for implementing a system according to embodiments of the present invention. CPU 1416 can execute one or more sequences of one or more instructions contained in system RAM 1414. Such instructions may be read into system RAM 1414 from a computer-readable medium, such as fixed disk 1422. Execution of the sequences of instructions contained in system RAM 1414 causes the CPU 1416 to perform process steps, such as the process steps described herein. One or more processors in a multi-processing arrangement may also be employed to execute the sequences of instructions contained in the memory. In alternative embodiments, hard-wired circuitry may be used in place of or in combination with software instructions to implement the invention. Thus, embodiments of the invention are not limited to any specific combination of hardware circuitry and software.

The terms “computer-readable medium” and “computer-readable media” as used herein refer to any medium or media that participate in providing instructions to CPU 1416 for execution. Such media can take many forms, including, but not limited to, non-volatile media, volatile media and transmission media. Non-volatile media include, for example, optical or magnetic disks, such as fixed disk 1422. Volatile media include dynamic memory, such as system RAM 1414. Transmission media include coaxial cables, copper wire and fiber optics, among others, including the wires that comprise one embodiment of bus 1410. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, a FLASHEPROM, any other memory chip or cartridge, a carrier wave, or any other medium from which a computer can read.

Various forms of computer-readable media may be involved in carrying one or more sequences of one or more instructions to CPU 1416 for execution. Bus 1410 carries the data to system RAM 1414, from which CPU 1416 retrieves and executes the instructions. The instructions received by system RAM 1414 can optionally be stored on fixed disk 1422 either before or after execution by CPU 1416.

While the foregoing is directed to the illustrative embodiment of the present invention, other and further embodiments of the invention may be devised without departing from the basic scope thereof, and the scope thereof is determined by the claims that follow.

1. A method of customizing a rule-based application, the method comprising:
designating a customizable element of a set as a customizable template; and
compiling said customizable element into at least one object to form a ruleset.

2. The method of claim 1, wherein said set comprises a ruleset.

3. The method of claim 1, further comprising parsing said set to detect said customizable element designated as a customizable template.

4. The method of claim 1, further comprising customizing said element.

5. The method of claim 1, wherein said element comprises a variable.

6. The method of claim 1, wherein said element comprises a rule.

7. The method of claim 1, wherein said element comprises a ruleset.

8. The method of claim 1, further comprising designating a ruleset of said set as a customizable ruleset template.

9. The method of claim 8, further comprising generating a customized ruleset from the customizable ruleset template.

10. The method of claim 1, further comprising enabling customization in a deployment environment.

11. The method of claim 1, further comprising enabling customization in a development environment.

12. The method of claim 1, further comprising re-editing a previously generated rule.

13. The method of claim 1, wherein a new ruleset is generated from a customizable ruleset template, and a pre-existing customizable rule template is associated with said new ruleset and is unchanged.

14. A system for customizing a rule-based application, the system comprising:
means for designating a customizable element of a set as a customizable template; and
means for compiling said customizable element into at least one object to form a ruleset.

15. The system of claim 14, wherein said set comprises a ruleset.

16. The system of claim 14, further comprising means for parsing said set to detect said customizable element designated as a customizable template.

17. The system of claim 14, further comprising means for customizing said element.

18. The system of claim 14, wherein said element comprises a variable.

19. The system of claim 14, wherein said element comprises a rule.

20. The system of claim 14, wherein said element comprises a ruleset.

21. The system of claim 14, further comprising means for designating a ruleset of said set as a customizable ruleset template.

22. The system of claim 21 further comprising means for generating a customized ruleset from said customizable ruleset template.

23. The system of claim 14 further comprising means for enabling customization in a deployment environment.

24. The system of claim 14 further comprising means for enabling customization in a development environment.

25. The system of claim 14 further comprising means for re-editing a previously generated rule.

26. A computer-readable media for storing software instructions for customizing a rule-based application, which when executed by a processor perform the steps of:
designating a customizable element of a set as a customizable template; and
compiling said customizable element into at least one object to form a ruleset.

27. The computer-readable media of claim 26, wherein said set comprises a ruleset.

28. The computer-readable media of claim 26, wherein said instructions further performing the step of parsing said set to detect said customizable element designated as a customizable template.

29. The computer-readable media of claim 26, wherein said instructions further performing the step of customizing said element.

30. The computer-readable media of claim 26, wherein said instructions further performing the step of designating a ruleset of said set as a customizable ruleset template.

31. The computer-readable media of claim 30, wherein said instructions further performing the step of generating a customized ruleset from the customizable ruleset template.
